(19) United States
(12) Patent Application Publication
(10) Pub. No.: US 2014/0278889 A1
(43) Pub. Date: Sep. 18, 2014

(54) SYSTEM AND METHOD FOR ACTIVITY AND GEOGRAPHIC RELATED CONSUMER INTERACTION

(71) Applicant: CINEMARK USA, INC., Plano, TX (US)

(72) Inventors: Douglas Scott FAY, Frisco, TX (US); Joseph Daniel GALYEAN, Carrollton, TX (US); Robert Fletcher CARMONY, Frisco, TX (US); James MEREDITH, Allen, TX (US)

(73) Assignee: CINEMARK USA, INC., Plano, TX (US)

(21) Appl. No.: 14/212,059

(22) Filed: Mar. 14, 2014

Related U.S. Application Data
(60) Provisional application No. 61/791,038, filed on Mar. 15, 2013.

(51) Int. Cl. G06Q 30/02

(52) U.S. Cl. CPC G06Q 30/0226
USPC 705/14.27; 705/14.64; 705/14.58

(57) ABSTRACT

A system and method directed at a consumer interaction system and program that provides an option to participate in said program, and provides incentives for participating in certain defined behavior, such as dimming the screen of or rendering silent a phone during the showing of a movie in a movie theater, participating in an activity in a particular geographic area, or making purchases.

### CROSS-REFERENCE TO RELATED APPLICATIONS

This application is based on, and claims benefit of and priority to, U.S. Provisional Application Ser. No. 61/791,038, entitled “System and Method for Activity and Geographic Related Consumer Interaction” filed Mar. 15, 2013, the contents of which are hereby incorporated in their entirety for all purposes.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

### Field of the Invention

This invention relates to digital consumer interaction. Specifically, it relates to a system and method for presenting a consumer interaction program based on a physical location or requested activity of the consumer.

Consumer interaction programs typically require interaction with customers based upon connecting one consumer-based factor, such as location or consumer preference, to an offer to the consumer of some sort of reward. Many applications (“Apps”) available from the Apple App Store or from the Android Market seek to connect consumers to retailers or advertisers, and deliver consumer-relevant data to the mobile device, such as directions or discount coupons. Generally, however, the increased presence of these mobile devices, and personal interconnectedness, has given rise to a mobile-device addicted culture. In many cases, the inappropriate use of a mobile device interferes with another's enjoyment of, or attention to, an event or activity. Talking, texting, and browsing the web can all be a distraction in an environment such as a movie theater, where silence and darkness is preferable.

Therefore, a need exists for a system and method of utilizing mobile devices to inhibit mobile-device interference with another's enjoyment of an activity by incentivizing the mobile-device user into compliance.

Additionally, consumers are often forced to carry multiple “loyalty” or “rewards” program membership cards or punch cards that allow them to compile points to be redeemed later. These cards can either be in the form of a basic punch card that is punched every time a consumer purchases a product, or it can be in the form of a plastic credit card-like structure that can be scanned to digitally register loyalty. In either case, the consumer is forced to carry additional cards for every store, restaurant, or service provider, making it burdensome on the consumer. If the consumer uses a plastic card, then the consumer is forced to check the status of their reward via a separate device.

Therefore, a need exists for a system and method for utilizing the mobile device to display loyalty program image that can be scanned in order to track consumer usage and incentivize the user to continue purchasing products and services at the business. The mobile device will also be able to instantaneously display the consumer's purchase history and how close he or she is to obtaining an award.

### BRIEF SUMMARY OF THE INVENTION

The present disclosure is directed at a consumer interaction system and program that provides an option to participate in said program, and provides incentives for participating in certain defined behavior, such as dimming the screen of or rendering silent a phone during the showing of a movie in a movie theater. It is also contemplated that this system will be able to track various customer activities and purchases to further incentivize participation and promote similar products and services. The consumer interaction system may also utilize a location based technology to better service the consumers.

A user selects to download a reward App on to their mobile device, where the reward App is tailored to the specific business offering the reward App. For example, a movie theater reward App tailored to interact with the user related to the viewing of movies at the movie theater. After the reward App is downloaded and opened, the user is provided an opportunity to register user data with the business or proceed without registration.

When the user launches the reward App on their mobile device, a query is made to a mobile server to retrieve the current settings for the reward App. Settings for the reward App may include a flag that enables the reward App to be disabled and/or designate a specific activity required to obtain a reward. Such an activity may include setting the number of consecutive minutes of reward App usage that are required to receive an award. For example, a movie theater may set a 90 continuous minute minimum usage time of the reward App before an award is earned by the user. Alternatively, a query to a mobile server can be made according to the location of the user's mobile device. Based on the location, the server will be able to identify the movie theatre and specific movie the user is attending and will be able to set the specific duration accordingly. For example, if the movie is 129 minutes long, the number of consecutive minutes required by the activity will be 129 minutes.

A user may launch the reward App with an action as simple as pressing the App button on their mobile device. In one disclosed embodiment relating to a movie theater, after launch of the reward App, the user presses the ‘Turn On’ button. This will cause the current time to be saved within the device, to be used as a ‘starting time’. In addition the display will be dimmed and the user will be instructed to mute their phone. At any point after the App has been turned-on, the user can exit the reward App by pressing the ‘Turn Off’ button, by closing/minimizing the App, or by accessing other Apps on the consumer mobile device. If the user exits using the ‘Turn Off’ button, the current time is compared against the saved ‘starting time’ to see if the App was used for the necessary continuous time required to receive an award. If so, a query is made to the mobile server to create a new coupon on the fly and assign it to this device and/or user. If a user is registered and logged in, the coupon will be assigned to their registered account. If a user is not registered the coupon will simply be assigned to the particular mobile device. The user is then taken to a screen showing the award details. If a user attempts to exit using the ‘Turn Off’ button before the award time duration is reached, a pop-up will appear alerting them to the fact that they have not used the reward App long enough to receive an award. If they continue and turn off, they will be taken to a screen explaining that they did not receive an award.

In another disclosed embodiment, the business may collect data regardless of whether an award was obtained or not. For example, the number of minutes that a user spent using the reward App may be collected and used as a performance metric. Another metric would be which concessions or movies titles the user has purchased. Additionally, the business may provide a list of currently available awards. For example, the user may press the Rewards button from anywhere within the reward App and a reward list is loaded to the user's mobile device based upon the information received from the mobile server. Such information may be related to a user or a specific mobile device.

In another disclosed embodiment, the business may allow the user to input or scan the App every time a purchase is made in order to further incentivize use. Repeated purchases would lead to additional rewards generated for the user or mobile device.

In still another embodiment, the App may use location-based technology or previous consumer activity history to generate targeted advertisement or offers for the user. For example if a user previously watched a science-fiction movie, the user would be alerted of the release of a movie in a similar genre. These targeted offers could also be based on the user previously purchasing, for example, popcorn. In that example, coupons for free popcorn would be awarded for participation in an activity.

### BRIEF DESCRIPTION OF THE SEVERAL VIEWS OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the invention is not limited to the precise arrangements and instrumentalities shown.

In the drawings:

FIG. 1 depicts a method for a consumer interaction and reward program to a consumer based on a physical location and activity of the consumer according to one embodiment of the present invention.

FIG. 2 illustrates a block diagram of an example of the disclosed system.

FIG. 3 illustrates the reward creation aspect of the disclosed method and system.

FIG. 4 illustrates the reward redemption aspect of the disclosed method and system.

FIG. 5 illustrates an embodiment of the consumer interaction application

FIG. 6 illustrates an embodiment of the consumer interaction application.

### DETAILED DESCRIPTION OF THE INVENTION

Before explaining at least one disclosed embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed are for purposes of description and should not be regarded as limiting.

It should be understood that any one of the features of the invention may be used separately or in combination with other features. Other systems, methods, features, and advantages of the present invention will be or become apparent to one with skill in the art upon examination of the drawings and the detailed description. It is intended that all such additional systems, methods, features, and advantages be included within this description, be within the scope of the present invention, and be protected by accompanying claims.

The present disclosure is described below with reference to the Figures in which various embodiments of the present invention are shown. The subject matter of the disclosure may, however, be embodied in many different forms and should not be construed as limited to the exemplary embodiments set forth herein.

The present disclosure provides for a method and system for presenting a consumer interaction and rewards program to a consumer based on a physical location, activity of the consumer, or both. Through the disclosed method and system, a retailer or provider may collect relevant data from a consumer, incentivize a consumer toward an action, ensure that action occurs, and provide a reward for a consumer for successfully completing the incentivized action. It will be understood by one of skill in the art that the physical location of the mobile device is but one factor to be used, and may not be used at all, in determining whether a user has been awarded a reward.

Referring to FIG. 1, a method is illustrated for the implementation of consumer interaction program based on the consumer's physical location and/or requested activity. The method begins with Start 101. A consumer is provided, on a mobile App on a consumer mobile device (“CMD”), an option to participate in the consumer interaction program in step 102.

Step 102 provides a screen or input request from the mobile App prompting a user to choose to participate or not to participate at that specific time. This screen or input may simply be an image that a user can choose that may display verbiage such as “enter reward mode.” The choice made by the user is then locally stored until requested by the mobile service provider.

In the next Step 104 the mobile service provider requests and obtains, in a first instance, data from the mobile App on the CMD. It will be understood by one of skill in the art that the mobile server would request this data via Wi-Fi, cellular, or other wireless technology that the CMD is connected to. Data may initially be locally stored according to the device's local hardware architecture and software. The mobile service provider may request the result of the user's participation response, the geographical location of the CMD, or a uniquely assigned id. Geographical location may be obtained through the device's inherent capabilities as is well known in the art, or may be entered by the user indicating the geographical location of the device. It will be understood by one of skill in the art that that the uniquely assigned id would be generated and saved in a customer database upon registration by the user prior to participating in the program.

Data collected from Step 104 is then sent to the mobile service provider. If the data that is collected indicates that the consumer wishes to participate in the consumer interactive program, the mobile service provider presents to the consumer an option to place the CMD into a reward receiving mode in Step 106. For example, one type of reward receiving mode of the mobile App issues instructions to the CMD to cause the display of the CMD to emit less lumens. This may be accomplished by limiting the lumen output by software instruction, displaying a graphical image that inherently produces fewer lumens, or displaying an alpha-numeric instruction readable to the consumer to instruct said consumer to cause the same effect of lesser lumen emission. Further, the mobile App may record the entry and exit time into and out of the reward receiving mode, respectively. Data relating to whether any other application on the CMD was accessed between the entry time and exit time of the CMD into the reward receiving mode may also be collected. In Step 107, the user selects to enter the reward receiving mode.

In Step 108, Data from Step 104 and 106 is sent to the mobile service provider after the reward receiving mode is exited. The reward saving mode may be exited manually by the consumer or automatically upon the detection of a particular activity, such as accessing any other application on the CMD. The data sent to the mobile service provider is compared to certain data parameters that are pre-defined by the App provider to determine whether a reward will be presented to the consumer. These comparisons may include whether the entry and exit time of the CMD into the reward receiving mode meet the duration of time required, along with the time of day. The geographical location could be compared to a predefined geographical boundary, where a reward is only issued if the CMD was inside the geographical boundary while in the reward receiving mode. If the comparisons indicate the data from the CMD is within the parameters, Step 110 provides rewards and or certificates to consumers on the CMD in the mobile App. The reward may either be associated with the uniquely assigned id or assigned to the App on the specific device. This reward or certificate may be later redeemed if verified against a database in the mobile service provider.

Lastly, in Step 112, the mobile App provides, separate from or in correlation with the reward receiving mode, consumer interest data based upon any data requested by the mobile service provider. For example the mobile service provider may request the geographical location, particular movie attended, concessions purchased, and duration the consumer remained in reward receiving mode. Such consumer interest data may be used for targeted promotions of relevant products, services, or announcements, which may or may not be related to the services or products offered by the mobile App provider.

The rewards are then displayed to the user. To redeem the reward the user simply displays the barcode in the reward details screen to the cashier, where it can be scanned or manually entered. Alternatively, the user may themselves display the barcode to a self-service point of sale terminal to redeem the reward. Exemplary rewards include, but are not limited to, coupons for a free or discounted food and beverages, or free movie tickets. The method ends with Step 113.

Referring now to FIG. 2, a reward program system according to one disclosed embodiment is shown. A CMD 200 is shown in wireless connection to a mobile service provider 220. The mobile service provider 220 is electronically connected to a network 210, or bus, and sends and receives data from the CMD 200, such as user identification. A customer database 250 is electronically connected to the network 210 and maintains information related to users, such as user identification. Coupon database 260 is electronically connected to the network 210 and maintains data related to rewards previously awarded, types of future rewards, and user specific rewards. Data maintained in the coupon database 260 may be correlated to data maintained in the customer database 250. If a user has been awarded a reward, the reward data is maintained in the coupon database 260 and the reward data is transmitted to the CMD 200. A point of sale terminal 230 is electronically attached to the network 210. The point of sale terminal may also be wirelessly connected to the CMD 200. Data related to a reward may be transmitted from the CMD 200 to the point of sale terminal 230 which is further electronically connected to the point of sale server 240. The reward data transmitted, from the CMD 200, is verified by the point of sale server 240 and coupon database 260 to determine if a reward may be used to purchase a good or service at the point of sale terminal 230.

Referring now to FIG. 3, a flow diagram of the reward creation process of one disclosed embodiment is shown. In step 301, the user exits the reward mode by affirmatively selecting ‘exit’ or “turn-off,” or participating in a predefined activity that when detected, causes the application to exit reward saving mode. Once the reward mode is exited, the duration of the time spent in reward mode is compared in step 302 to the pre-defined duration requirement. If the time spent is greater than the amount required, the App will make a query 303 to the mobile service provider 220 to request a reward coupon. The mobile service provider will then generate a coupon code 304 and transmit the coupon code to the customer database server 250. The customer database server 250 will then assign the coupon code 305 to a uniquely assigned id or device and transmit this information to the coupon database server 260 to update its table associating a particular coupon codes with a unique id or devices.

FIG. 4 illustrates the reward redemption aspect of a disclosed embodiment. The reward redemption takes place after the process discussed in FIGS. 1 and 2 take place. That is, a user may redeem the award after they have successfully been awarded a coupon. After a reward has been issued to the App in a particular CMD, or to a registered user (uniquely assignable id), the reward may be displayed on the screen of the CMD. The displayed reward can take the form of an uniquely coded image that is known to one of skill in the art such as a barcode or other pixilated code. In step 401, the user places the displayed reward coupon under a scanner at a point of sale terminal configured to read the coupon. In 402, the point of sale terminal transmits the coupon code to the point of sale server 240 which verifies the coupon, executes the purchase, and transmits a confirmation to the point of sale terminal 230 to display to the user. The point of sale server 240 transmits the coupon verification information in step 403 to the coupon database server 260 to mark the coupon as redeemed.

In FIG. 5, yet another embodiment of a consumer interaction system is illustrated. This embodiment is directed toward a movie theatre loyalty program application that tracks customer purchases or experiences and incentivizes them to continue their interaction. A meter that tracks the customers various activities 501 is shown. Upon completion of a pre-defined number of activities, a different reward 502 is awarded to the user. Further, various activities unlock “badges” shown in the display bar 503. The activities that unlock the badges and produce rewards detected when a user scans the consumer interaction application is similar to the point of sale terminal 230 disclosed herein.

FIG. 6 shows the same embodiment identified in FIG. 5, but after a user has completed enough activities to unlock the first reward 601.

One skilled in the art will recognize that different embodiments may be formed in a similar manner having different characteristics depending on the need, performance, or some other criteria. It will thus be appreciated by those skilled in the art that changes could be made to the embodiments described above without departing from the broad inventive concept thereof. It is understood, therefore, that the invention disclosed herein is not limited to the particular embodiments disclosed, but it is intended to cover modifications within the spirit and scope of the present invention as defined by the appended claims.

What is claimed is:

1. A consumer interaction method on a consumer mobile device, the method comprising the steps of:
providing to a consumer, via a mobile application, an option to participate in the consumer interaction program;
transmitting user data from the mobile application to a mobile service provider as a result of the consumer's election to participate in consumer interaction program;
providing to the consumer the option to enter a reward receiving mode once the consumer has elected the consumer interaction program;
transmitting the data representing consumer's willingness to enter reward receiving mode, wherein the data represents that the consumer is willing to participate in reward receiving mode;
comparing total activity with predefined requirements upon consumer's exiting of reward receiving mode;
providing a reward coupon to mobile application to be displayed to consumer if the total activity meets the predefined requirements; and
providing feedback data from mobile application back to a mobile service provider.

2. The method of claim 1, wherein the step of transmitting the data representing consumer's willingness includes the step of transmitting a current activity status

3. The method of claim 2, wherein the current activity status may be a current time of the consumer mobile device when the reward receiving mode is started.

4. The method of claim 2, wherein the current activity status may be a geographical position of the consumer mobile device when the reward receiving mode is started.

5. The method of claim 1, wherein the step of transmitting the data representing consumer's willingness includes the step of transmitting instruction to the consumer to comply with reward receiving mode requirements.

6. The method of claim 1, wherein the step of transmitting the data representing consumer's willingness includes the step of transmitting a command for forced compliance with reward receiving mode requirements.

7. The method of claim 1, wherein the user data may be a geographical location of the consumer mobile device.

8. The method of claim 1, wherein the user data may be a uniquely assignable id.

9. The method of claim 1, wherein the user data may be reward coupon information.

10. The method of claim 1, wherein the reward receiving mode includes reducing the lumens emitted by the screen of the consumer mobile device.

11. The method of claim 1, wherein the total activity includes a duration of time.

12. The method of claim 1, wherein the total activity includes recognition of a geographical location.

13. The method of claim 1, wherein the predefined requirement is a numerical value of the time required for the consumer to spend in the reward receiving mode.

14. The method of claim 1, wherein the predefined requirement is an acceptable geographical location of the consumer mobile device while the consumer was in reward receiving mode.

15. The method of claim 1, wherein the exiting of reward receiving mode includes the consumer's affirmative election to exit.

16. The method of claim 1, wherein the exiting of reward receiving mode includes the accessing of any other mobile application on the consumer mobile device.

17. The method of claim 1, wherein the feedback data includes consumer interest information based on the data collected by the mobile application.

18. The method of claim 1, wherein the feedback data includes consumer activity information based on the data collected by the mobile application.

19. A consumer interaction program system, system comprising:
a consumer mobile device for displaying a mobile application, wherein the consumer mobile device remotely connects to a network;
a mobile service provider for managing interactions between servers and a mobile application running on the consumer mobile device;
a point of sale terminal to scan the consumer mobile device;
a customer database maintained by the mobile application provider;
a coupon database maintained by the mobile application provider; and
a point of sale server to verify reward coupons maintained by the coupon database.

20. A method for redeeming a reward coupon displayed on a consumer mobile device comprising:
the consumer mobile device displaying the reward coupon at a point of sale terminal;
the point of sale terminal reading the reward coupon from the consumer mobile device;
the point of sale terminal communicating with a point of sale server to verify the reward coupon;
the point of sale service providing confirmation to the point of sale terminal; and
a coupon database server communicating with the point of sale server and updating records of coupon redemption.
